(19) United States
(12) Patent Application Publication
(10) Pub. No.: US 2007/0047757 A1
(43) Pub. Date: Mar. 1, 2007

(54) DIAPHRAGM FOR MICRO-ELECTROACOUSTIC DEVICE

(75) Inventors: TSUNG-LUNG YANG, TU CHENG (TW); SHIH-CHIA CHIU, TU CHENG (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: FOXCONN TECHNOLOGY CO., LTD., TU CHENG (TW)

(21) Appl. No.: 11/308,835

(22) Filed: May 12, 2006

(30) Foreign Application Priority Data
Aug. 26, 2005 (CN) 200510036906.X

(51) Int. Cl. H04R 11/02

(52) U.S. Cl. 381/423

(57) ABSTRACT

A diaphragm for a micro-electroacoustic transducer includes a central portion and a peripheral portion surrounding the central portion. The central portion is deformed to integrally form a corrugation which may increase the rigidity and the resonance frequency of the diaphragm. A plurality of elongated indents are integrally formed at the peripheral portion for decreasing the resonance frequency of the diaphragm. The low frequency characteristics of a loudspeaker fitted with the diaphragm of the embodiments therefore is adjustable by adjusting the number of the indents.

### FIELD OF THE INVENTION

1. Field of the Invention

The present invention relates generally to a micro-electroacoustic device, and more particularly to a diaphragm for a micro-electroacoustic device.

2. Description of Related Art

Sound is one important means by which people communicate with each other, thus creating new methods for sound transference which allows greater communication between people. Electroacoustic transducers are key components in transferring sound. A typical electroacoustic transducer has a magnetic circuit in which a magnetic field generated by a magnet passes through a base member, a magnetic core and a diaphragm and returns to the magnet again. When an oscillating electric current is supplied to a coil wound around the magnetic core, the corresponding oscillating magnetic field generated by the coil is then superimposed onto the magnetostatic field of the magnetic circuit. The resulting oscillation generated in the diaphragm is then transmitted to the air as sound. The basic loudspeaker, in which electric energy is converted to acoustic energy, is a typical electroacoustic transducer. There are many different types of loudspeakers, including electrostatic loudspeakers, piezoelectric loudspeakers, and moving-coil loudspeakers.

Nowadays, mobile phones are widely used and loudspeakers are important components packaged within mobile phones. As design style for mobile phones emphasizes lightness, thinness, shortness, smallness, energy-efficiency, low cost, the space available for loudspeakers within mobile phones is therefore limited. Furthermore, as more and more mobile phones are being used to play MP3s, the rated power of the loudspeakers needs to increase. The space occupied by a loudspeaker mainly depends on the maximum deformation displacement of a diaphragm of the loudspeaker.

Therefore, it is desired to design a new diaphragm for micro-electroacoustic transducers which may undergo an increased power while occupying a smaller amount of space.

### SUMMARY OF INVENTION

A diaphragm for a micro-electroacoustic transducer in accordance with a preferred embodiment of the present invention comprises a central portion and a peripheral portion surrounding the central portion. The central portion is deformed to integrally form a corrugation which may increase the rigidity of the diaphragm. A plurality of elongated indents are integrally formed at the peripheral portion for decreasing the resonance frequency of the diaphragm. The low frequency characteristic of a loudspeaker fitted with the diaphragm of the embodiment can therefore be adjusted to meet a predetermined value by adjusting the number of the indents and the number of the corrugation.

Other advantages and novel features of the present invention will become more apparent from the following detailed description when taken in conjunction with the accompanying drawings, in which:

### BRIEF DESCRIPTION OF DRAWINGS

Many aspects of the present apparatus and method can be better understood with reference to the following drawings. The components in the drawings are not necessarily drawn to scale, the emphasis instead being placed upon clearly illustrating the principles of the present apparatus. Moreover, in the drawings, like reference numerals designate corresponding parts throughout the several views.

FIG. 1 is a partly cut-away isometric view of a diaphragm in accordance with a first embodiment of the present invention;

FIG. 2 is a partly cut-away isometric view of a diaphragm in accordance with a second embodiment of the present invention;

FIG. 3 is similar to FIG. 2 but viewed from an reversed aspect;

FIG. 4 is a partly cut-away isometric view of a diaphragm in accordance with a third embodiment of the present invention;

FIG. 5 is a partly cut-away isometric view of a diaphragm in accordance with a forth embodiment of the present invention; and

FIG. 6 is a partly cut-away isometric view of a diaphragm in accordance with a fifth embodiment of the present invention.

### DETAILED DESCRIPTION

Reference will now be made to the drawing figures to describe the preferred embodiment in detail.

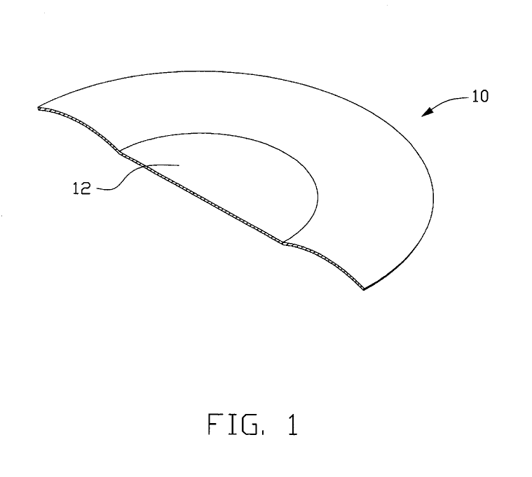

FIG. 1 is a partly cut away isometric view of a diaphragm 10 in accordance with a first embodiment of the present invention. The diaphragm 10 is used for micro-electroacoustic transducers, such as the loudspeakers of mobile phones or notebooks. In the preferred embodiment, the diaphragm 10 is round in shape viewed from above. The diaphragm 10 is made of a polymeric material, such as PEI, PI, PP, PEN or PET. A corrugation is integrally formed at a central portion of the diaphragm 10 by deforming it. In this embodiment, the corrugation is a circular recess section 12. The corrugation integrally formed at the central portion of the diaphragm 10 may increase the rigidity of the diaphragm 10. That is, compared with conventional diaphragms without corrugation, the maximum deformation displacement of the diaphragm 10 of the preferred embodiment of the present invention is less when undergoing the same power. Thus, a loudspeaker fitted with the diaphragm 10 of the preferred embodiment occupy smaller space than a loudspeaker using conventional diaphragms. Understandably, a loudspeaker fitted with the diaphragm 10 of the preferred embodiment and occupying the same space as loudspeakers fitted with conventional diaphragms can undergo larger amounts of power. This is due to the rigidity of the diaphragm of the preferred embodiment being larger than that of a conventional diaphragm.

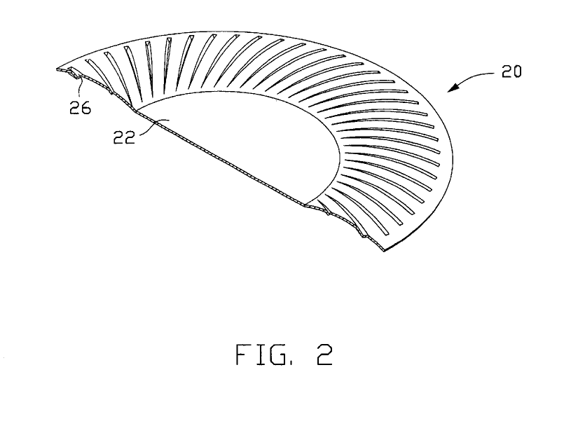

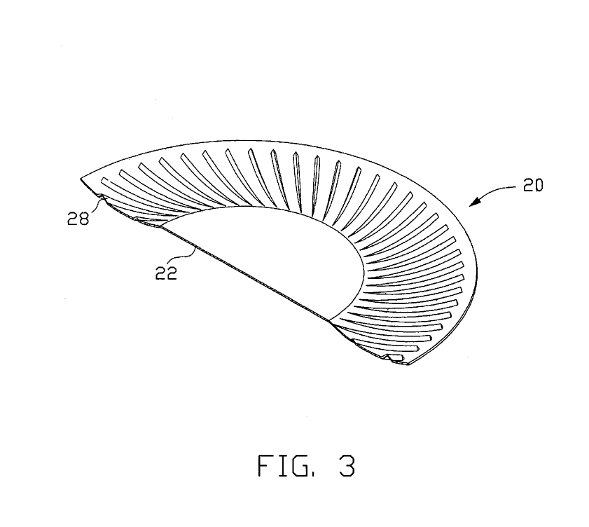

FIGS. 2 and 3 show a diaphragm 20 in accordance with a second embodiment of the present invention. The diaphragm 20 comprises a central portion and a peripheral portion surrounding the central portion. A corrugation is integrally formed at the central portion of the diaphragm 20 by deforming it. In this embodiment, the corrugation is a circular recess section 22 formed at one surface of the diaphragm 20. A plurality of elongated indents 26 is integrally formed at the peripheral portion of the surface of the diaphragm 20. The indents 26 extend radially from adjacent the central portion to adjacent the peripheral edge of the diaphragm 20. Each indent 26 has a V-shaped cross section. The width and depth of the indent 26 increases gradually in a direction from the central portion to the peripheral edge. A plurality of elongated ribs 28 corresponding to the respective indents 26 is formed at the peripheral portion of the diaphragm 20 and protrudes from an opposite surface of the diaphragm 20, as shown in FIG. 3. The indents 26 integrally formed at the peripheral portion of the diaphragm 20 can decrease the low resonant frequency of the diaphragm 20 which as a result functions as a mechanism for adjusting a low frequency characteristic of a loudspeaker fitted with the diaphragm 20 to meet a predetermined value specified to the loudspeaker.

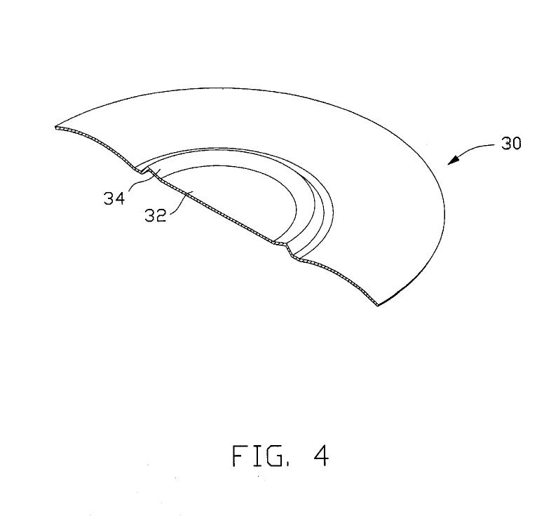

FIG. 4 shows a diaphragm 30 in accordance with a third embodiment of the present invention. A corrugation is integrally formed at the central portion of the diaphragm 30 by deforming it. In this embodiment, the corrugation comprises a circular recess section 32 recessed into one surface of the diaphragm 30, and an annular ridge 34 protruding from the surface of the diaphragm 30 and surrounding the circular recess section 32. The ridge 34 has a V-shaped cross section. An annular groove (not labeled) is integrally formed at an opposite surface of the diaphragm 20 at a location corresponding to the ridge 34.

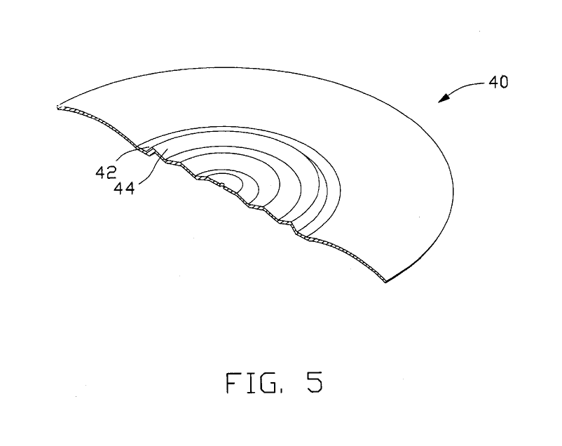

FIG. 5 shows a diaphragm 40 in accordance with a forth embodiment of the present invention. The central portion of the diaphragm 40 is depressed which results in a circular recess section 42 being formed at the central portion of one surface of the diaphragm 40. A pair of annular ridges 44 are integrally formed on the recess section 42 and protrude it.

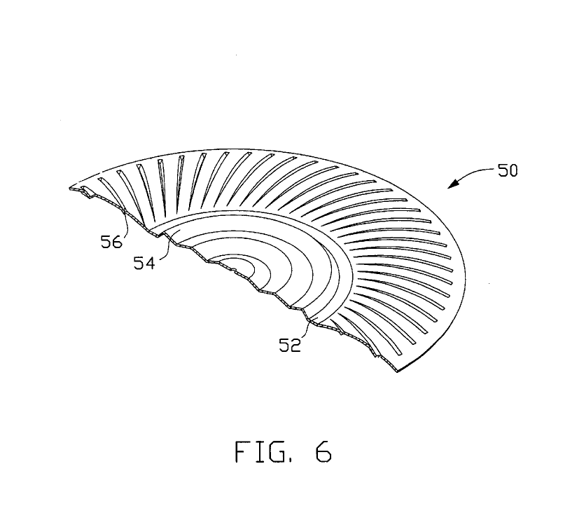

FIG. 6 shows a diaphragm 50 in accordance with a fifth embodiment of the present invention. The diaphragm 50 comprises a central portion and a peripheral portion surrounding the central portion. A corrugation is integrally formed at the central portion of the diaphragm 50 by deforming it. In this embodiment, the corrugation comprises a circular recess section 52 recessed into a surface of the diaphragm 50, and a pair of annular ridges 54 formed at the circular recess section 52 and protruding from the surface of the diaphragm 50. A plurality of elongated indents 56 are integrally formed at the peripheral portion of the diaphragm 50 and sink into the surface of the diaphragm 50. The indents 56 extend radially from adjacent the central portion to adjacent the peripheral edge of the diaphragm 50. Each indent has a V-shaped cross section. The size of the cross section increases gradually in a direction from the central portion to the peripheral edge. A plurality of elongated ribs (not labeled) corresponding to the respective indents 56 are formed at and protrude from an opposite surface of the diaphragm 50.

In order to test the effect of the corrugation formed at the central portion of the diaphragm and the indents formed at the peripheral portion of the diaphragm, the applicant has conducted a model analysis on different diaphragms supposing that the mass and boundary condition of the diaphragms are the same and the diaphragms have no residual stress. Table 1 shows the results of the simulation.

TABLE 1

| | | Model I | Model II |
|---|---|---|---|
| | | low resonant | low resonant |
| | | frequency of | frequency of |
| Serial | | the diaphragm | the diaphragm |
| No. | Diaphragms | (Hz) | (Hz) |
| 1 | a circular diaphragm without | 389 | 809 |
| | recess sections and indents | | |
| 2 | a circular diaphragm with a | 1152 | 2064 |
| | recess section formed at | | |
| | the central portion thereof | | |
| 3 | a circular sheet with a | 763 | 1538 |
| | recess section formed at | | |
| | the central portion thereof | | |
| | and 60 indents formed at | | |
| | the peripheral portion | | |
| | thereof | | |
| 4 | a circular diaphragm with | 1258 | 2092 |
| | a recess section formed at | | |
| | the central portion thereof | | |
| | and an annular ridge | | |
| | surrounding the recess | | |
| | section | | |
| 5 | a circular diaphragm with | 1386 | 2101 |
| | a recess section formed at | | |
| | the central portion thereof | | |
| | and three annular ridges | | |
| | surrounding the recess | | |
| | section | | |
| 6 | a circular diaphragm with | 1213 | 2093 |
| | a recess section formed at | | |
| | the central portion thereof | | |
| | and three annular ridges | | |
| | surrounding the recess | | |
| | section and ten indents | | |
| | formed at the peripheral | | |
| | portion thereof | | |
| 7 | A circular diaphragm with | 1049 | 1873 |
| | a recess section formed at | | |
| | the central portion thereof | | |
| | and three annular ridges | | |
| | surrounding the recess | | |
| | section and twenty indents | | |
| | formed at the peripheral | | |
| | portion thereof | | |
| 8 | A circular diaphragm with | 977 | 1781 |
| | a recess section formed at | | |
| | the central portion thereof | | |
| | and three annular ridges | | |
| | surrounding the recess | | |
| | section and forty indents | | |
| | formed at the peripheral | | |
| | portion thereof | | |
| 9 | A circular diaphragm with | 914 | 1767 |
| | a recess section formed at | | |
| | the central portion thereof | | |
| | and three annular ridges | | |
| | surrounding the recess | | |
| | section and sixty indents | | |
| | formed at the peripheral | | |
| | portion thereof | | |

From table I, one can conclude that the recess section and the ridges formed at the central portion of a diaphragm can increase the rigidity, and accordingly the low resonant frequency, of the diaphragm while the indents formed at the peripheral portion of the diaphragm can decrease the low resonant frequency of the diaphragm.

In the embodiments described above, the corrugations, such as the recess section and the ridges integrally formed at the central portion of the diaphragm can increase the rigidity of the diaphragm. Thus, compared with conventional diaphragms without corrugation formed thereon, the maximum deformation displacement of the diaphragm of the preferred embodiments is less when undergoing the same power. Therefore, a loudspeaker fitted with the diaphragm of the preferred embodiments occupy smaller space than a loudspeaker using conventional diaphragms. Understandably, a loudspeaker fitted with the diaphragm of the preferred embodiments and occupying the same space as loudspeakers fitted with conventional diaphragms can undergo larger amounts of power. The indents integrally formed at the peripheral portion of the diaphragm change the boundary condition of the diaphragm which as a result decreases the low resonant frequency of the diaphragm. The low frequency characteristics of a loudspeaker fitted with the diaphragm of the embodiments are therefore can be adjusted by increasing/decreasing the number of the indents and the corrugations to meet a predetermined value specified to the loudspeaker.

It is believed that the present invention and its advantages will be understood from the foregoing description, and it will be apparent that various changes may be made thereto without departing from the spirit and scope of the invention or sacrificing all of its material advantages, the examples hereinbefore described merely being preferred or exemplary embodiments.

What is claimed is:

1. A diaphragm for a micro-electroacoustic transducer, comprising a central portion and a peripheral portion surrounding the central portion, wherein at least one corrugation is integrally formed at the central portion by deforming the diaphragm.

2. The diaphragm as described in claim 1, wherein the at least one corrugation comprises a circular recessed section recessed into one surface of the diaphragm.

3. The diaphragm as described in claim 2, wherein the at least one corrugation further comprises an annular ridge formed at and protruding from the recessed section.

4. The diaphragm as described in claim 1, wherein the at least one corrugation comprises an annular ridge protruding from one surface of the diaphragm.

5. The diaphragm as described in claim 1, wherein a plurality of elongated indents are integrally formed at the peripheral portion and sinking from one surface of the diaphragm.

6. The diaphragm as described in claim 5, wherein the indents extend radially from adjacent to the central portion to adjacent to the peripheral edge of the diaphragm.

7. The diaphragm as described in claim 6, wherein each of the indents has a V-shaped cross section.

8. The diaphragm as described in claim 7, wherein the size of the indent increases gradually from the central portion to the peripheral portion.

9. A diaphragm for a micro-electroacoustic transducer, comprising a central portion and a peripheral portion surrounding the central portion, wherein a plurality of indents are integrally formed at the peripheral portion by deforming the diaphragm.

10. The diaphragm as described in claim 9, wherein the indents extend radially from adjacent the central portion to adjacent a peripheral edge of the diaphragm.

11. The diaphragm as described in claim 10, wherein at least one corrugation is integrally formed at the central portion.

12. The diaphragm as described in claim 11, wherein the at least one corrugation comprises a circular recessed section sinking from one surface of the diaphragm.

13. The diaphragm as described in claim 12, wherein the at least one corrugation further comprises an annular ridge formed at and protruding from the recessed section.

14. The diaphragm as described in claim 11, wherein a plurality of ribs integrally protrudes from an opposite surface of the diaphragm at locations corresponding to the indents.

15. The diaphragm as described in claim 9, wherein each of the indents has V-shaped cross section.

16. The diaphragm as described in claim 15, wherein the size of the cross section increases gradually in a direction from the central portion to the peripheral portion.

17. A diaphragm for a micro-electroacoustic transducer comprising a central portion and a peripheral portion surrounding the central portion, wherein the central portion is recessed from the peripheral portion and the peripheral portion has a plurality of indents formed thereon.

18. The diaphragm as described in claim 17, wherein the indents radially extend from a place near the central portion to a place near an outer edge of the peripheral portion.

19. The diaphragm as described in claim 18, wherein each of the indents has a larger width and depth at the place near the outer edge of the peripheral portion.

20. The diaphragm as described in claim 18, wherein the central portion forms at least a ridge thereon.
